(19) United States
(12) Patent Application Publication
(10) Pub. No.: US 2016/0247518 A1
(43) Pub. Date: Aug. 25, 2016

(54) APPARATUS AND METHOD FOR IMPROVING A PERCEPTION OF A SOUND SIGNAL

(71) Applicant: Huawei Technologies Co., Ltd., Shenzhen (CN)

(72) Inventors: Bjoern Schuller, Munich (DE); Felix Weninger, Munich (DE); Christian Kirst, Munich (DE); Peter Grosche, Munich (DE)

(21) Appl. No.: 15/147,549

(22) Filed: May 5, 2016

Related U.S. Application Data
(63) Continuation of application No. PCT/EP2013/073959, filed on Nov. 15, 2013.

(51) Int. Cl. G10L 21/0272; G10L 21/0216; G10L 25/84; H04S 5/00; H04S 7/00

(52) U.S. Cl. CPC G10L 21/0272; H04S 5/00; H04S 7/30; G10L 25/84; G10L 21/0216; H04S 2420/01

(57) ABSTRACT

The present invention relates to an apparatus for improving a perception of a sound signal, the apparatus comprising: a separation unit configured to separate the sound signal into at least one speech component and at least one noise component; and a spatial rendering unit configured to generate an auditory impression of the at least one speech component at a first virtual position with respect to a user, when output via a transducer unit, and of the at least one noise component at a second virtual position with respect to the user, when output via the transducer unit.

### CROSS-REFERENCE TO RELATED APPLICATIONS

This application is a continuation of International Application No. PCT/EP2013/073959, filed on Nov. 15, 2013, which is hereby incorporated by reference in its entirety.

### TECHNICAL FIELD

The present application relates to the field of sound generation, and particularly to an apparatus and a method for improving a perception of a sound signal.

### BACKGROUND

Common audio signals are composed of a plurality of individual sound sources. Musical recordings, for example, comprise several instruments during most of the playback time. In the case of speech communication, the sound signal often comprises, in addition to the speech itself, other interfering sounds which are recorded by the same microphone such as ambient noise or other people talking in the same room.

In typical speech communication scenarios, the voice of a participant is captured using one or multiple microphones and transmitted over a channel to the receiver. The microphones capture not only the desired voice but also undesired background noise. As a result, the transmitted signal is a mixture of speech and noise components. In particular, in mobile communication, strong background noise often severely affects the customers' experience or sound impression.

Noise suppression in spoken communication, also called “speech enhancement”, has received a large interest for more than three decades and many methods have been proposed to reduce the noise level in such mixtures. In other words, such speech enhancement algorithms are used with the goal to reduce background noise. As shown in FIG. 1, given a noisy speech signal (e.g., a single-channel mixture of speech and background noise), the signal S is separated, e.g. by a separation unit 10, in order to obtain two signals: a speech component SC, also referred to as “enhanced speech signal”, and a noise component NC, also referred to as “estimated noise signal”. The enhanced speech signal SC should contain less noise than the noisy speech signal S and provide higher speech intelligibility. In the optimal case, the enhanced speech signal SC resembles the original clean speech signal. The output of a typical speech enhancement system is a single channel speech signal.

The prior-art solutions are based, for example, on subtraction of such noise estimates in the time-frequency domain, or estimation of a filter in the spectral domain. These estimations can be made by assumptions on the behaviour of noise and speech, such as stationarity or non-stationarity, and statistical criteria such as minimum mean squared error. Furthermore, they can be constructed by knowledge gathered from training data, e.g., as in more recent approaches such as non-negative matrix factorization (NMF) or deep neural networks. The non-negative matrix factorization is, for example, based on a decomposition of the power spectrogram of the mixture into a non-negative combination of several spectral bases, each associated to one of the present sources. In all those approaches, the enhancement of the speech signal is achieved by removing the noise from the signal S.

Summarizing the above, these speech enhancement methods transform a single- or multi-channel mixture of speech and noise into a single-channel signal with the goal of noise suppression. Most of these systems rely on the online estimation of the “background noise”, which is assumed to be stationary, i.e., to change slowly over time. However, this assumption is not always verified in the case of real noisy environments. Indeed, the passing by of a truck, the closing of a door or the operation of some kinds of machines such as a printer, are examples of non-stationary noises, which can frequently occur and negatively affect the user experience or sound impression in everyday speech communication—in particular in mobile scenarios.

Particularly in the non-stationary case, the estimation of such noise components from the signal is an error-prone step. As a result of the imperfect separation, current speech enhancement algorithms, which aim at suppressing the noise contained in a signal, do often not lead to a better user experience or sound impression

### SUMMARY

Embodiments of the present invention provide a transit card, so as to maintain integrity of a signal in a transmission process and prevent interference leakage of the signal.

It is the object of the invention to provide an improved technique of sound generation.

This object is achieved by the features of the independent claims. Further implementation forms are apparent from the dependent claims, the description and the figures.

According to a first aspect, an apparatus for improving a perception of a sound signal is provided, the apparatus comprising a separation unit configured to separate the sound signal into at least one speech component and at least one noise component; and a spatial rendering unit configured to generate an auditory impression of the at least one speech component at a first virtual position with respect to a user, when output via a transducer unit, and of the at least one noise component at a second virtual position with respect to the user, when output via the transducer unit.

The present invention does not aim at providing a conventional noise suppression, e.g. a pure amplitude-related suppression of noise signals, but aims at providing a spatial distribution of estimated speech and noise. Adding such spatial information to the sound signal allows the human auditory system to exploit spatial localization cues in order to separate speech and noise sources and improves the perceived quality of the sound signal.

Further, the perceptual quality is enhanced because typical speech enhancement artifacts such as musical noise are less prominent when avoiding the suppression of noise.

A more natural way of communication is achieved by using the principles of the present invention which enhances speech intelligibility and reduces listener fatigue.

Given a mixture of foreground speech and background noise, as for instance present in a multi-channel front-end with a frequency domain independent component analysis, electronic circuits are configured to separate speech and noise to obtain a speech and a noise signal component using various solutions for speech enhancement and are further configured to distribute speech and noise to different positions in three-dimensional space using various solutions for spatial audio rendering using multiple loudspeakers, i.e. two or more loudspeakers, or a headphone.

The present invention advantageously provides that the human auditory system can exploit spatial cues to separate speech and noise. Further, speech intelligibility and speech quality is increased, and a more natural speech communication is achieved as natural spatial cues are regenerated.

The present invention advantageously restores spatial cues which cannot be transmitted in conventional single-channel communication scenarios. These spatial cues can be exploited by the human auditory system in order to separate speech and noise sources. Avoiding the suppression of noise as typically done by current speech enhancement approaches further increases the quality of the speech communication as little artifacts are introduced.

The present invention advantageously provides an improved robustness against imperfect separation and less artifacts occurring compared to the number of artifacts which would occur if noise suppression is used. The present invention can be combined with any speech enhancement algorithm. The present invention advantageously can be used for arbitrary mixtures of speech and noise, no change of the communication channel and/or speech recording is necessary.

The present invention advantageously provides an efficient exploitation even with one microphone and/or one transmission channel. Advantageously, many different rendering systems are possible, e.g. systems comprising two or more speakers, or stereo headphones. The apparatus for improving a perception of a sound signal may comprise the transducer unit or the transducer unit may be a separate unit. For example, the apparatus for improving a perception of a sound signal may be a smartphone or tablet, or any other device, and the transducer unit may be the loudspeakers integrated into the apparatus or device, or the transducer unit may be an external loudspeaker arrangement or headphones.

In a first possible implementation form of the apparatus according to the first aspect, the first virtual position and the second virtual position are spaced, spanning a plane angle with respect to the user of more than 20 degree of arc, preferably more than 35 degree of arc, particularly preferred more than 45 degree of arc.

This advantageously allows that the listener or user perceives the spatial separation of noise and speech signal.

In a second possible implementation form of the apparatus according to the first aspect as such or according to the first implementation form of the first aspect, the separation unit is configured to determine a time-frequency characteristic of the sound signal and to separate the sound signal into the at least one speech component and the at least one noise component based on the determined time-frequency characteristic.

In signal processing, time-frequency analysis, generating time-frequency characteristics, comprises those techniques that study a signal in both the time and frequency domains simultaneously, using various time-frequency representations.

In a third possible implementation form of the apparatus according to the second possible implementation form of the apparatus according to the first aspect, the separation unit is configured to determine the time-frequency characteristic of the sound signal during a time window and/or within a frequency range.

Therefore, various characteristic time constants can be determined and subsequently be used for advantageously separating the sound signal into at least one speech component and at least one noise component.

In a fourth possible implementation form of the apparatus according to the third implementation form of the first aspect or according to the second possible implementation form of the apparatus according to the first aspect, the separation unit is configured to determine the time-frequency characteristic based on a non-negative matrix factorization, computing a basis representation of the at least one speech component and the at least one noise component.

The non-negative matrix factorization allows visualizing the basis columns in the same manner as the columns in the original data matrix.

In a fifth possible implementation form of the apparatus according to the third implementation form of the first aspect or according to the second possible implementation form of the apparatus according to the first aspect, the separation unit is configured to analyze the sound signal by means of a time series analysis with regard to stationarity of the sound signal and to separate the sound signal into the at least one speech component corresponding to least one non-stationary component based on the stationary analysis and into the at least one noise component corresponding to least one stationary component based on the stationary analysis.

Various characteristic stationarity properties obtained by time-series analysis can be used to advantageously separate stationary noise components from non-stationary speech components.

In a sixth possible implementation form of the apparatus according to the first aspect as such or according to any of the preceding implementation forms of the first aspect, the transducer unit comprises at least two loudspeakers arranged at different azimuthal angles with respect to the user.

This advantageously provides a sound localization of the signal components for the user, i.e. the listener's ability to identify the location or origin of a detected sound in direction and distance.

In a seventh possible implementation form of the apparatus according to the first aspect as such or according to any of the preceding implementation forms of the first aspect, the transducer unit comprises at least two loudspeakers arranged in a headphone.

This advantageously provides the possibility for reproducing a binaural effect resulting in a natural listening experience that spatially transcends the sound signal.

In an eighth possible implementation form of the apparatus according to the first aspect as such or according to any of the preceding implementation forms of the first aspect, the spatial rendering unit is configured to use amplitude panning and/or delay panning to generate the auditory impression of the at least one speech component at the first virtual position, when output via the transducer unit, and of the at least one noise component at the second virtual position, when output via the transducer unit.

This advantageously constitutes a low-complexity solution providing the possibility for using various different arrangements of loudspeakers to achieve a perceived spatial separation of the noise and speech signal.

In a ninth possible implementation form of the apparatus according to the eighth implementation form of the first aspect, the spatial rendering unit is configured to generate binaural signals for the at least two transducers by filtering the at least one speech component with a first head-related transfer function corresponding to the first virtual position and filtering the at least one noise component with a second head-related transfer function corresponding to the second virtual position.

Therefore, virtual positions can span the entire three-dimensional hemisphere which advantageously provides a natural listening experience and enhanced separation.

In a tenth possible implementation form of the apparatus according to the first aspect as such or according to any of the preceding implementation forms of the first aspect, the first virtual position is defined by a first azimuthal angle range with respect to a reference direction and/or the second virtual position is defined by a second azimuthal angle range with respect to the reference direction.

In an eleventh possible implementation form of the apparatus according to the tenth implementation form of the first aspect, the second azimuthal angle range is defined by one full circle.

Thus, the perception of a non-localized noise source is created which advantageously supports the separation of speech and noise sources in the human auditory system.

In an twelfth possible implementation form of the apparatus according to the eleventh implementation form of the first aspect, the spatial rendering unit is configured to obtain the second azimuthal angle range by reproducing the at least one noise component with a diffuse characteristic realized using decorrelation.

This diffuse perception of the noise source advantageously enhances the separation of speech and noise sources in the human auditory system.

According to a second aspect, the invention relates to a mobile device comprising an apparatus according to any of the preceding implementation forms of the first aspect and a transducer unit, wherein the transducer unit is provided by at least one pair of loudspeakers of the device.

According to a third aspect, the invention relates to a method for improving a perception of a sound signal, the method comprising the following steps of: separating the sound signal into at least one speech component and at least one noise component, e.g. by means of a separation unit; and generating an auditory impression of the at least one speech component at a first virtual position with respect to a user, when output via a transducer unit, and of the at least one noise component at a second virtual position with respect to the user, when output via the transducer unit, e.g. by means of a spatial rendering unit.

In a first possible implementation form of the method according to the third aspect, the first virtual position and the second virtual position are spaced, spanning a plane angle with respect to the user of more than 20 degree of arc, preferably more than 35 degree of arc, particularly preferred more than 45 degree of arc.

The methods, systems and devices described herein may be implemented as software in a Digital Signal Processor (DSP) in a microcontroller or in any other processor or as hardware circuit within an application specific integrated circuit (ASIC) or in a field-programmable gate array (FPGA) which is an integrated circuit designed to be configured by a customer or a designer after manufacturing-hence field-programmable.

### BRIEF DESCRIPTION OF THE DRAWINGS

Further embodiments of the invention will be described with respect to the following figures, in which:

FIG. 1 shows a schematic diagram of a conventional speech enhancement approach separating a noise speech signal into a speech and a noise signal;

FIG. 2 shows a schematic diagram of a source localization in single channel communication scenarios, where speech and noise sources are localized in the same direction;

FIG. 3 shows a schematic block diagram of a method for improving a perception of a sound signal according to an embodiment of the invention;

FIG. 4 shows a schematic diagram of a device comprising an apparatus for improving a perception of a sound signal according to a further embodiment of the invention; and

FIG. 5 shows a schematic diagram of an apparatus for improving a perception of a sound signal according to a further embodiment of the invention.

### DETAILED DESCRIPTION

In the associated figures, identical reference signs denote identical or at least equivalent elements, parts, units or steps. In addition, it should be noted that all of the accompanying drawings are not to scale.

The technical solutions in the embodiments of the present invention are described clearly and completely in the following with detailed reference to the accompanying drawings in the embodiments of the present invention.

Apparently, the described embodiments are only some embodiments of the present invention, rather than all embodiments. Based on the described embodiments of the present invention, all other embodiments obtained by persons of ordinary skill in the art without making any creative effort shall fall within the protection scope of the present invention.

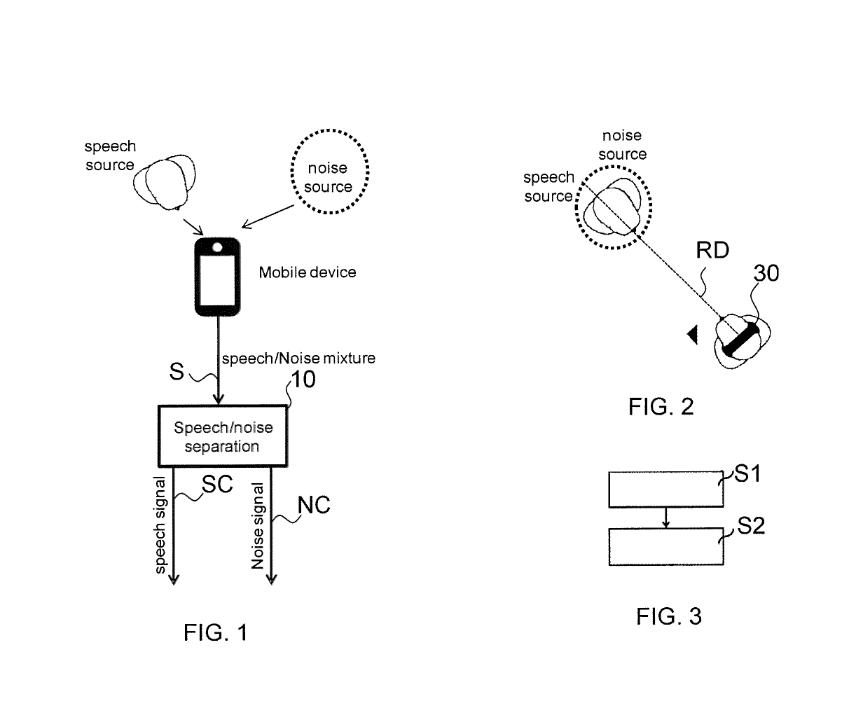

Before describing the various embodiments of the invention in detail, the findings of the inventors shall be described based on FIGS. 1 and 2.

As mentioned above, although speech enhancement is a well-studied problem, current technologies still fail to provide a perfect separation of the speech/noise mixture into clean speech and noise components. Either the speech signal estimate still contains a large fraction of noise or parts of the speech are erroneously removed from the estimated speech signal. Several reasons cause this imperfect separation, e.g.:
spatial overlap between speech and noise sources coming from the same direction which is often occurring for diffuse or ambient noise sources, e.g. street noise, and
spectral overlap between speech and noise sources e.g., consonants in speech resemble white noise or undesired background speech overlapping with desired foreground speech.

Consequences of the imperfect separation using current technologies are, for example:

important parts of speech are suppressed,

speech may sound unnatural, the quality is affected by artifacts,

noise is only partly suppressed; the speech signal still contains a large fraction of noise, and/or

remaining noise may sound unnatural (e.g., “musical noise”).

As a result of the imperfect separation, current speech enhancement algorithms which aim at suppressing the noise contained in a signal do often not lead to a better user experience. Although the resulting speech signal may contain less noise, i.e. the signal-to-noise-ratio is higher, the perceived quality may be lower as a result of unnatural sounding speech and/or noise. Also the speech intelligibility which measures the degree to which speech can be understood is not necessarily increased.

Aside from the problems introduced by the speech enhancement algorithms, there is one fundamental problem of single-channel speech communication: All single-channel speech signal transmission remove spatial information from the recorded acoustic scene and the different acoustic sources contained therein. In natural listening and communication scenarios, acoustic sources such as speakers and also noise sources are located at different positions in 3D space. The human auditory systems exploit this spatial information by evaluating spatial cues (such as interaural-time and -level differences) which allow separating acoustic sources arriving from different directions. These spatial cues are actually highly important for the separation of acoustic sources in the human auditory system and play an important role for speech communication, see the so-called “cocktail-party effect”.

In conventional single-channel communication, all speech and noise sources are localized in the same direction as illustrated in FIG. 2. As a result, the human auditory system cannot evaluate spatial cues in order to separate the different sources. Accordingly, all speech and noise sources, illustrated by the dotted circle, are localized in the same direction with respect to a reference direction RD of a user who has a headphone as the transducer unit 30, as illustrated in FIG. 2. As a result, the human auditory system of the user cannot evaluate spatial cues in order to separate the different sources. This reduces the perceptual quality and in particular the speech intelligibility in noisy environments.

Embodiments of the invention are based on the finding that a spatial distribution of estimated speech and noise (instead of suppression) allow to improve the perceived quality of noisy speech signals.

The spatial distribution is used to place speech sources and noise sources at different positions. The user localizes speech and noise sources as arriving from different directions, as will be explained in more detail based on FIG. 5. This approach has two main advantages opposed to conventional speech enhancement algorithms aiming at suppressing the noise. First, spatial information which was not contained in the single-channel mixture is added to the signal which allows the human auditory system to exploit spatial localization cues in order to separate speech and noise sources. Second, the perceptual quality is enhanced because typical speech enhancement artefacts such as musical noise are less prominent when avoiding the suppression of noise. A more natural way of communication is achieved by using this invention which enhances speech intelligibility and reduces listener fatigue.

FIG. 3 shows a schematic block diagram of a method for improving a perception of a sound signal according to an embodiment of the invention.

The method for improving the perception of the sound signal may comprise the following steps:

As a first step of the method, separating S1 the sound signal S into at least one speech component SC and at least one noise component NC, e.g. by means of a separation unit 10, is conducted, for example as described based on FIG. 1.

As a second step of the method, generating S2 an auditory impression of the at least one speech component SC at a first virtual position VP1 with respect to a user is performed, when output via a transducer unit 30, e.g. by means of a spatial rendering unit 20. Further, generating of the at least one noise component NC at a second virtual position VP2 with respect to the user is performed, when output via the transducer unit 30, e.g. by means of the spatial rendering unit 20.

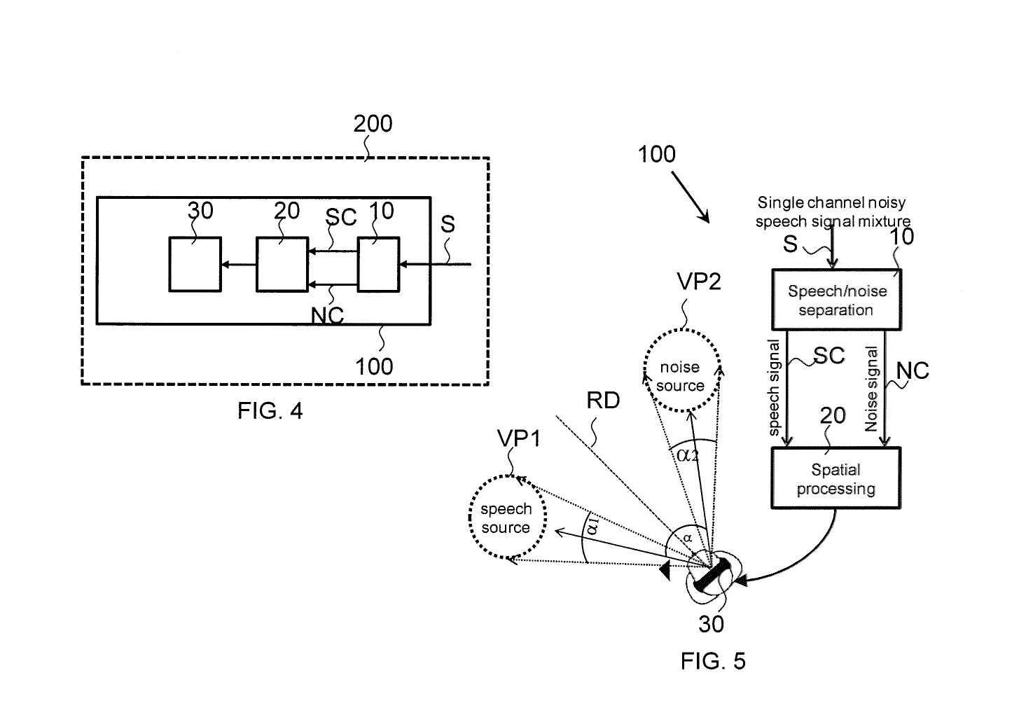

FIG. 4 shows a schematic diagram of a device comprising an apparatus for improving a perception of a sound signal according to a further embodiment of the invention.

FIG. 4 shows an apparatus 100 for improving a perception of a sound signal S. The apparatus 100 comprises a separation unit 10 and a spatial rendering unit 20, and a transducer unit 30.

The separation unit 10 is configured to separate the sound signal S into at least one speech component Sc and at least one noise component NC.

The spatial rendering unit 20 is configured to generate an auditory impression of the at least one speech component SC at a first virtual position VP1 with respect to a user, when output via the transducer unit 30, and of the at least one noise component NC at a second virtual position VP2 with respect to the user, when output via the transducer unit 30.

Optionally, in one embodiment of the present invention, the apparatus 100 may be implemented or integrated into any kind of mobile or portable or stationary device 200, which is used for sound generation, wherein the transducer unit 30 of the apparatus 100 is provided by at least one pair of loudspeakers. The transducer unit 30 may be part of the apparatus 100, as shown in FIG. 4, or part of the device 200, i.e., integrated into apparatus 100 or device 200, or a separate device, e.g., separate loudspeakers or headphones.

The apparatus 100 or the device 200 may be constructed as all kind of speech-based communication terminals with a means to place acoustic sources in space around the listener, e.g., using multiple loudspeakers or conventional headphones. In particular, mobile devices, smartphones and tablets may be used as apparatus 100 or device 200 which are often used in noisy environments and are thus affected by background noise. Further, the apparatus 100 or device 200 may be a teleconferencing product, in particular featuring a hands-free mode.

FIG. 5 shows a schematic diagram of an apparatus for improving a perception of a sound signal according to a further embodiment of the invention.

The apparatus 100 comprises a separation unit 10 and a spatial rendering unit 20, and may optionally comprise a transducer unit 30.

The separation unit 10 may be coupled to the spatial rendering unit 20, which is coupled to the transducer unit 30. The transducer unit 30, as illustrated in FIG. 5, comprises at least two loudspeakers arranged in a headphone.

As explained based on FIG. 1, the sound signal S may comprise a mixture of multiple speech and/or noise signals or components of different sources. However, all the multiple speech and/or noise signals are, for example, transduced by a single microphone or any other transducer entity, for example by a microphone of a mobile device, as shown in FIG. 1.

One speech source, e.g. a human voice, and one—not further defined—noise source, represented by the dotted circle are present and are transduced by the single microphone.

In one embodiment of the present invention, the separation unit 10 is adapted to apply conventional speech enhancement algorithms to separate the noise component NC from the speech component SC in the time-frequency domain, or estimation of a filter in the spectral domain. These estimations can be made by assumptions on the behavior of noise and speech, such as stationarity or non-stationarity, and statistical criteria such as minimum mean squared error.

Time series analysis is about the study of data collected through time. A stationary process is one whose statistical properties do not or are assumed to not change over time.

Furthermore, speech enhancement algorithms may be constructed by knowledge gathered from training data, such as non-negative matrix factorization or deep neural networks.

Stationarity of noise may be observed during intervals of a few seconds. Since speech is non-stationary in such intervals, noise can be estimated simply by averaging the observed spectra. Alternatively, voice activity detection can be used to find the parts where the talker is silent and only noise is present.

Once the noise estimate is obtained, it can be re-estimated on-line to better fit the observation, by criteria such as minimum statistics, or minimizing the mean squared error. The final noise estimate is then subtracted from the mixture of speech and noise to obtain the separation into speech components and noise components.

Accordingly, the speech estimate and noise estimate sum up to the original signal.

The spatial rendering unit 20 is configured to generate an auditory impression of the at least one speech component SC at a first virtual position VP1 with respect to a user, when output via a transducer unit 30, and of the at least one noise component NC at a second virtual position VP2 with respect to the user, when output via a transducer unit 30.

Optionally, in one embodiment of the present invention, the first virtual position VP1 and the second virtual position VP2 are spaced by a distance, thus, spanning a plane angle α with respect to the user of more than 20 degree of arc, preferably more than 35 degree of arc, particularly preferred more than 45 degree of arc.

Alternative embodiments of the apparatus 100 may comprise or are connected to a transducer unit 30 which comprises, instead of the headphones, at least two loudspeakers arranged at different azimuthal angles with respect to the user and the reference direction RD.

Optionally, the first virtual position VP1 is defined by a first azimuthal angle range α1 with respect to a reference direction RD and/or the second virtual position VP2 is defined by a second azimuthal angle range α2 with respect to the reference direction RD.

In other words, the virtual spatial dimension or the virtual spatial extension of the first virtual position VP1 and/or the spatial extension of the second virtual position VP2 corresponds to the first azimuthal angle range α1 and/or the second azimuthal angle range α2, respectively.

Optionally, the second azimuthal angle range al is defined by one full circle, in other words the virtual location of the second virtual position VP2 is diffuse or non discrete, i.e. ubiquitous. The first virtual position VP1 can in contrast be highly localized, i.e. restricted to a plane angle of less than 5°. This advantageously provides a spatial contrast between the noise source and the speech source.

Optionally, the spatial rendering unit 20 may be configured to obtain the second azimuthal angle range α2 by reproducing the at least one noise component NC with a diffuse characteristic realized using decorrelation.

The apparatus 100 and the method provide a spatial distribution of estimated speech and noise. The spatial distribution is configured to place speech sources and noise sources at different positions. The user localizes speech and noise sources as arriving from different directions, as illustrated in FIG. 5.

Optionally, in one embodiment of the present invention, a loudspeaker and/or headphone based transducer unit 30 is used: a loudspeaker setup can be used which comprises loudspeakers in at least two different positions, i.e. at least two different azimuth angles, with respect to the listener.

Optionally, in one embodiment of the present invention, a stereo setup with two speakers placed at −30 and +30 degrees is provided. Standard 5.1 surround loudspeaker setups allow for positioning the sources in the entire azimuth plane. Then, amplitude panning is used, e.g., using Vector Base Amplitude Panning (VBAP) and/or delay panning, which facilitates positioning speech and noise sources as directional sources at arbitrary position between the speakers.

To achieve the desired effect of better speech/noise separation in the human auditory system, the sources should at least be separated by −20 degrees.

Optionally, in one embodiment of the present invention, the noise source components are further processed in order to achieve the perception of diffuse source. Diffuse sources are perceived by the listener without any directional information; diffuse sources are coming from “everywhere”; the listener is not able to localize them.

The idea is to reproduce speech sources as directional sources at a specific position in space as described before and noise sources as diffuse sources without any direction. This mimics natural listening environments where noise sources are typically located further away than the speech sources which give them a diffuse character. As a result, a better source separation performance in the human auditory system is provided.

The diffuse characteristic is obtained by first decorrelating the noise sources and playing them over multiple speakers surrounding the listener.

Optionally, in one embodiment of the present invention, when using headphones or loudspeakers with crosstalk cancellation, it is possible to present binaural signals to the user. These have the advantage to resemble a very natural three-dimensional listening experience where acoustic sources can be placed all around the listener. The placement of acoustic sources is obtained by filtering the signals with Head-Related-Transfer-Functions (HRTFs).

Optionally, in one embodiment of the present invention, the speech source is placed as a frontal directional source and the noise sources as diffuse sources coming from all around. Again, decorrelation and HRTF filtering is used for the noise to obtain diffuse source characteristics. General diffuse sound source rendering approaches are performed.

Speech and noise are rendered such that they are perceived by the user at different directions. Diffuse field rendering of noise sources can be used to enhance the separability in the human auditory system.

In further embodiments, the separation unit may be a separator, the spatial rendering unit may be a spatial separator and the transducer unit may be a transducer arrangement.

From the foregoing, it will be apparent to those skilled in the art that a variety of methods, systems, computer programs on recording media, and the like, are provided.

The present disclosure also supports a computer program product including computer executable code or computer executable instructions that, when executed, causes at least one computer to execute the performing and computing steps described herein.

Many alternatives, modifications, and variations will be apparent to those skilled in the art in light of the above teachings. Of course, those skilled in the art readily recognize that there are numerous applications of the invention beyond those described herein.

While the present invention has been described with reference to one or more particular embodiments, those skilled in the art recognize that many changes may be made thereto without departing from the scope of the present invention. It is therefore to be understood that within the scope of the appended claims and their equivalents, the inventions may be practiced otherwise than as specifically described herein.

In the claims, the word “comprising” does not exclude other elements or steps, and the indefinite article “a” or “an” does not exclude a plurality. A single processor or other unit may fulfill the functions of several items recited in the claims.

The mere fact that certain measures are recited in mutually different dependent claims does not indicate that a combination of these measured cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems.

What is claimed is:

1. An apparatus for improving a perception of a sound signal, the apparatus comprising:
a separation unit configured to separate the sound signal into at least one speech component and at least one noise component; and
a spatial rendering unit configured to generate an auditory impression of the at least one speech component at a first virtual position with respect to a user, when output via a transducer unit, and of the at least one noise component at a second virtual position with respect to the user, when output via the transducer unit.

2. The apparatus according to claim 1, wherein the first virtual position and the second virtual position are spaced, spanning a plane angle with respect to the user of more than 20 degree of arc.

3. The apparatus according to claim 1, wherein the separation unit is configured to determine a time-frequency characteristic of the sound signal and to separate the sound signal into the at least one speech component and the at least one noise component based on the determined time-frequency characteristic.

4. The apparatus according to claim 3, wherein the separation unit is configured to determine the time-frequency characteristic of the sound signal during a time window and/or within a frequency range.

5. The apparatus according to claim 3, wherein the separation unit is configured to determine the time-frequency characteristic based on a non-negative matrix factorization, computing a basis representation of the at least one speech component and the at least one noise component.

6. The apparatus according to claim 3, wherein the separation unit is configured to:
analyze the sound signal by means of a time series analysis with regard to stationarity of the sound signal; and
separate the sound signal into the at least one speech component corresponding to least one non-stationary component based on the stationary analysis and into the at least one noise component corresponding to least one stationary component based on the stationary analysis.

7. The apparatus according to claim 1, wherein the transducer unit comprises at least two loudspeakers arranged at different azimuthal angles with respect to the user.

8. The apparatus according to claim 1, wherein the transducer unit comprises at least two loudspeakers arranged in a headphone.

9. The apparatus according to claim 1, wherein the spatial rendering unit is configured to use amplitude panning and/or delay panning to generate the auditory impression of the at least one speech component at the first virtual position, when output via the transducer unit, and of the at least one noise component at the second virtual position, when output via the transducer unit.

10. The apparatus according to claim 9, wherein the spatial rendering unit is configured to generate binaural signals for the at least two transducers by filtering the at least one speech component with a first head-related transfer function corresponding to the first virtual position and filtering the at least one noise component with a second head-related transfer function corresponding to the second virtual position.

11. The apparatus according to claim 1, wherein the first virtual position is defined by a first azimuthal angle range with respect to a reference direction and/or the second virtual position is defined by a second azimuthal angle range with respect to the reference direction.

12. The apparatus according to claim 11, wherein the second azimuthal angle range is defined by one full circle.

13. The apparatus according to claim 12, wherein the spatial rendering unit is configured to obtain the second azimuthal angle range by reproducing the at least one noise component with a diffuse characteristic using decorrelation.

14. The apparatus according to claim 1, wherein the first virtual position and the second virtual position are spaced, spanning a plane angle with respect to the user of more than 35 degree of arc.

15. The apparatus according to claim 1, wherein the first virtual position and the second virtual position are spaced, spanning a plane angle with respect to the user of more than 45 degree of arc.

16. A device comprising an apparatus according to claim 1, wherein the transducer unit of the apparatus is provided by at least one pair of loudspeakers of the device.

17. A method for improving a perception of a sound signal CS), the method comprising:
separating the sound signal into at least one speech component and at least one noise component; and
generating an auditory impression of the at least one speech component at a first virtual position with respect to a user, when output via a transducer unit, and of the at least one noise component at a second virtual position with respect to the user, when output via the transducer unit.

18. The method according to claim 17, wherein the first virtual position and the second virtual position are spaced, spanning a plane angle with respect to the user of more than 20 degree of arc.

19. The method according to claim 17, wherein the first virtual position and the second virtual position are spaced, spanning a plane angle with respect to the user of more than 35 degree of arc.

20. The method according to claim 17, wherein the first virtual position and the second virtual position are spaced, spanning a plane angle with respect to the user of more than 45 degree of arc.
